(19) United States
(12) Patent Application Publication
(10) Pub. No.: US 2017/0126098 A1
(43) Pub. Date: May 4, 2017

(54) Rotating Electric Machine

(71) Applicant: Hitachi, Ltd., Tokyo (JP)

(72) Inventors: Youko FURUKAWA, Tokyo (JP); Ryuuichirou IWANO, Tokyo (JP); Daisuke KORI, Tokyo (JP); Motonobu IIZUKA, Tokyo (JP); Takayuki KOYAMA, Tokyo (JP); Kazuhiro OGAWA, Tokyo (JP); Shigeki NAKAE, Tokyo (JP)

(21) Appl. No.: 15/337,212

(22) Filed: Oct. 28, 2016

(30) Foreign Application Priority Data
Oct. 30, 2015 (JP) 2015-213632

(51) Int. Cl. H02K 9/04; H02K 3/18

(52) U.S. Cl. CPC H02K 9/04; H02K 3/18

(57) ABSTRACT

The present invention provides a rotating electric machine comprising: a stator; a rotor disposed in such a manner that the outer peripheral surface of the rotor faces the inner peripheral surface of the stator; and a plurality of coil supports that support between poles of a coil forming the rotor, wherein the coil supports are detachably configured with respect to the rotor, at least one of the coil supports is provided with a fin formed of a member different from that of the coil support, and the fin is provided in such a manner that a windway through which a swirl flow occurring with the rotation of the rotor passes is formed between the coil and the fin.

### BACKGROUND OF THE INVENTION

The present invention relates to a rotating electric machine, and in particular to a cooling structure of the rotating electric machine.

In general, a rotating electric machine such as asynchronous motor and a power generator has afield coil on a rotor side, and an armature coil on a stator side, and therefore a current flowing through each coil causes a Joule loss. Heat generated by the Joule loss increases the coil temperature, to cause an insulating coating to deteriorate, and there is a possibility that burnout of the insulating coating may cause an accident such as a short circuit. In order to avoid this risk, an allowable temperature value is set for each coil, and a thermal design is performed in consideration of a cooling structure.

JP 2014-180092 A is known as a technique for solving such a cooling performance problem. In JP 2014-180092 A, a laminated steel plate that forms a rotor is provided with cooling fins to form a windway, thereby cooling the coil.

In addition, JP 2007-189849 A is known as a similar technique. JP 2007-189849 A discloses a structure in which in order to prevent the ventilation and cooling airflow from a gap from being blocked by a support, a windway is provided between a coil and a shaft to perform cooling.

Moreover, JP 2007-123328 A is known as a similar technique. JP 2007-123328 A discloses a structure in which a support is provided with ventilation grooves, and an axial flow flowing through a gap is partially taken into the ventilation grooves, thereby improving cooling of a coil through a part coming in contact with the support.

### SUMMARY OF THE INVENTION

Such techniques relating to patent literatures 1, 2 and 3 basically depend on the ventilation and cooling by an axial flow; and there exists a problem that it is difficult to achieve a cooling effect in a region in which the flow velocity and flow rate of the axial flow decrease, In addition, a means for eliminating a temperature difference that occurs between forward and backward in the rotational direction is not taken into consideration. Therefore, the temperature distribution may occur both in the axial direction and in the circumferential direction. As the result, the coil temperature increases to the highest in a coil region located backward in the rotational direction, in which the flow velocity of the axial flow is the lowest. Meanwhile, the coil temperature decreases to the lowest in a coil region located forward in the rotational direction, in which the flow velocity of the axial flow is the highest. In such situations, there is a concern that the temperature difference may become larger. A design must be made in such a manner that when a temperature difference occurs in the coil, the high temperature side falls within a range of an allowable temperature value. Therefore, there is a concern that excessive cooling performance is required from the viewpoint of the low temperature side. In this case, the design leads to high costs and low efficiency. Moreover, there is also a concern that When a temperature difference occurs in the coil, heat elongation, and a stress caused by the heat elongation vary on a position basis, and the balance of the rotor gets worse, resulting in a decrease in life and reliability.

The present invention has been made taking the above-described problems into consideration, and an object of the present invention is to provide, more efficiently and at lower cost, a means for eliminating a difference in temperature of a field coil caused by the flow velocity and flow rate in the axial direction, and for eliminating the temperature difference that occurs between forward and backward in the rotational direction, so as to uniformize the temperature distribution of the field coil.

In order to achieve the above-described object, the present invention provides a rotating electric machine comprising: a stator 10; a rotor 7 disposed in such a manner that the outer peripheral surface of the rotor 7 faces the inner peripheral surface of the stator 10; and a plurality of coil supports 4 that support between poles of a coil 2 forming the rotor 7, wherein: the coil supports 4 are detachably configured with respect to the rotor 7; at least one of the coil supports 4 is provided with a fin 5 formed of a member different from that of the coil support 4; and the fin 5 is provided in such a manner that a windway through which a swirl flow occurring with the rotation of the rotor 7 passes is formed between the coil 2 and the fin 5.

According to the present invention, a means for enabling further uniformization of the temperature distribution in the axial direction and the temperature distribution in the circumferential direction irrespective of the flow velocity in the axial direction can be realized more efficiently and at lower costs, and therefore a highly reliable rotating electric machine can be provided.

### BRIEF DESCRIPTION OF THE DRAWINGS

FIG. 1A is a diagram illustrating a schematic configuration (cross section in the radial direction) of a rotating electric machine according to a first embodiment of the present invention;

FIG. 1B is a diagram illustrating a schematic configuration cross section in the axial direction) of a rotating electric machine according to the first embodiment of the present invention;

FIG. 2A is a diagram illustrating a structure (cross section in the radial direction) of a general conventional rotating electric machine;

FIG. 2B is a diagram illustrating a structure (cross section in the axial direction) and a ventilation path of the general conventional rotating electric machine;

FIG. 3 is a diagram illustrating a schematic configuration of a rotating electric machine according to a second embodiment of the present invention;

FIG. 4A is a diagram illustrating a schematic configuration (cross section in the axial direction) of a rotating electric machine according to a third embodiment of the present invention;

FIG. 4B is a diagram illustrating a schematic configuration (cross section in the radial direction) of the rotating electric machine according to the third embodiment of the present invention;

FIG. 4C is a diagram illustrating a schematic configuration (cross section in the radial direction) of the rotating electric machine according to the third embodiment of the present invention;

FIG. 4D is a diagram illustrating a schematic configuration (cross section in the radial direction) of the rotating electric machine according to the third embodiment of the present invention;

FIG. 5A is a diagram illustrating a schematic configuration of a fin according to a fourth embodiment of the present invention;

FIG. 5B is a diagram (right side view) illustrating a schematic configuration of the tin according to the fourth embodiment of the present invention;

FIG. 5C is a diagram (bottom view) illustrating a schematic configuration of the fin according to the fourth embodiment of the present invention;

FIG. 6 is a diagram illustrating a schematic configuration of a rotating electric machine according to a fifth embodiment of the present invention;

FIG. 7 is a diagram illustrating a schematic configuration of a rotating electric machine according to a sixth embodiment of the present invention;

FIG. 8A is a diagram illustrating a schematic configuration of a fin according to a seventh embodiment of the present invention;

FIG. 8B is a diagram (right side view) illustrating a schematic configuration of the fin according to the seventh embodiment of the present invention;

FIG. 8C is a diagram (bottom view) illustrating a schematic configuration of the fin according to the seventh embodiment of the present invention; and

FIG. 9 is a diagram illustrating a schematic configuration of a compressor system according to an eighth embodiment of the present invention.

### DETAILED DESCRIPTION OF THE INVENTION

A rotating electric machine according to an embodiment of the present invention will be described with reference to the accompanying drawings as below.

As a cooling structure for preventing the temperature of a coil of a rotating electric machine from increasing, it is known that the end part of a rotor is provided with a fan for feeding a refrigerant in the axial direction to ventilate and cool a gap between the rotor and a stator.

When paying attention to the rotor, the rotor forms a plurality of field pole pairs each having a wound coil, and in order to support the field coils, a plurality of coil supports are intermittently provided between the poles. The coil supports block the ventilation, and therefore the field coils each have a part that is hardly cooled. In addition, from a structural point of view, there is a difference in cooling performance between forward and backward in the rotational direction, and a field coil conductor located backward in the rotational direction is hardly exposed to the wind, and therefore is hardly cooled.

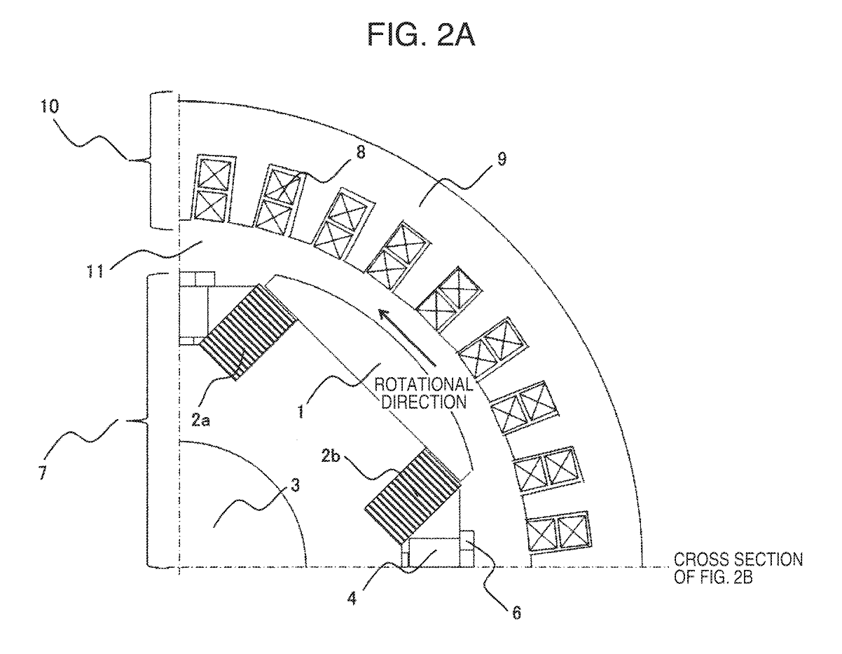

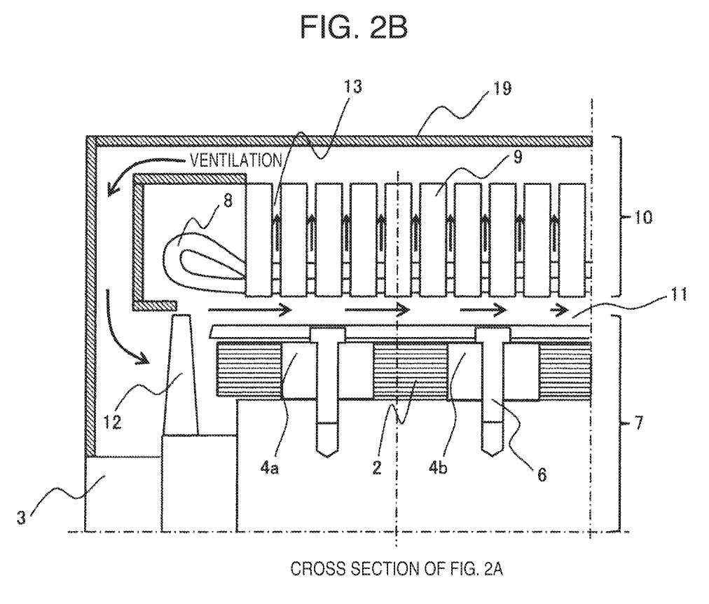

First of all, as a comparative example, a structure of the rotating electric machine will be described with reference to FIG. 2A and FIG. 2B. FIG. 2B indicates ventilation paths by using arrows. FIG. 2B is an axial cross-sectional view illustrating a half (½) of a rotating electric machine that includes a stator 10, and a rotor 7 having a structure symmetric with respect to the axial center. FIG. 2A is across-sectional view of a broken line part indicated in FIG. 2B, and illustrates a quarter (¼) in the circumferential direction.

As shown with the arrows of FIG. 2B, the axial ventilation airflow generated by a fan 12 at the end part of the rotor cools the surface of the rotor 7 and the surface of the stator 10, and causes a refrigerant to pass through a plurality of ducts 13, thereby cooling an armature coil 8 and a stator core 9.

In this case, the flow velocity in the axial direction decreases with the increasing distance away from the fan 12, and a flow rate also decreases, In particular, in the case of a symmetric structure in which the fans 12 are disposed on both sides of a shaft respectively as shown in FIG. 2B, the axial flow velocity becomes substantially 0 at the axial center, causing the cooling performance to decrease, and consequently the temperature increases in this part, which may cause a difference in temperature between coil regions.

In addition, as shown in FIG. 2A, comparing a field coil 2a located forward in a rotational direction of a pole shoe 1 with a field coil 2b located backward in the rotational direction of the pole shoe 1, the field coil 2b located backward in the rotational direction is hardly exposed to a refrigerant, and therefore the temperature of the field coil 2b becomes higher than the temperature of the field coil 2a, which may cause a difference in temperature between coil regions. The temperature distribution in the circumferential direction (the rotational direction) occurs together with the temperature distribution in the axial direction, and consequently the temperature difference between the highest temperature and the lowest temperature of the field coil 2 becomes larger.

Moreover, the heat of the field coil is removed by ventilation cooling from the surface of the rotor. As shown in FIG. 2A, coils 2a, 2b coming in contact with the coil supports 4 respectively each have a structure in which the ventilation cooling in the axial direction is blocked, and therefore the temperature of the field coil tends to increase at the axial center.

Thus, the deterioration is accelerated in the locally heated parts, and therefore there is a possibility that the reliability of insulation and the like will be impaired. Furthermore, since it is necessary to cool the temperature of the highest temperature region to an allowable temperature value or less, measures for increasing the flow rate and the flow velocity as a whole are required, and therefore, for example, a larger fan is required, which may lead to an increase in costs and a decrease in efficiency.

### Example 1

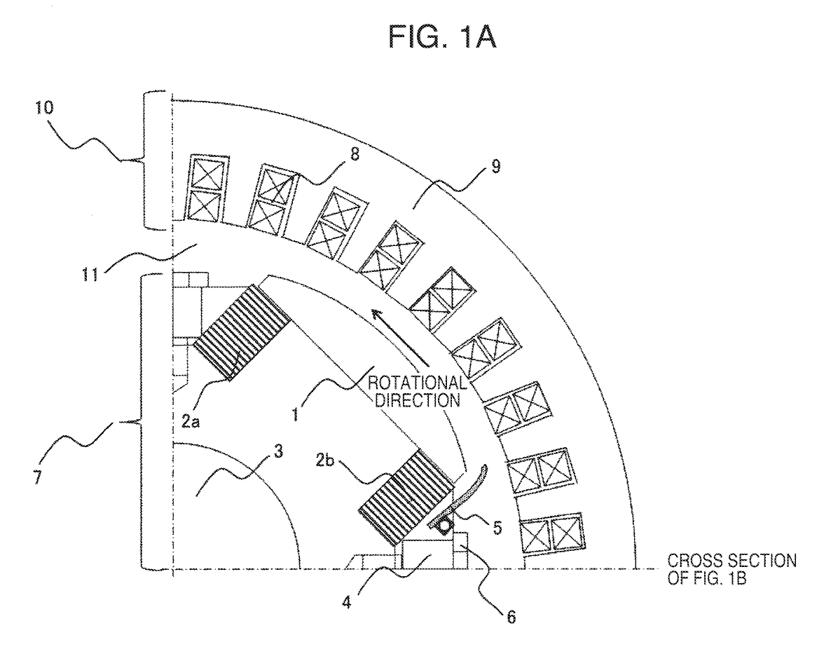

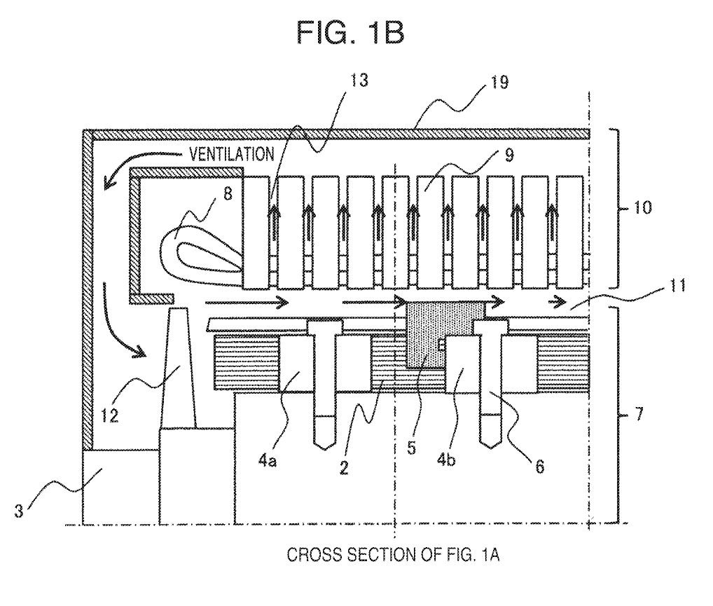

An example 1 of the present invention will be described with reference to FIG. 1A and FIG. 1B.

As with FIG. 2B, FIG. 1B is an axial cross-sectional view illustrating a half (½) of a rotating electric machine that includes a stator 10, and a rotor 7 having a structure symmetric with respect to the axial center, and FIG. 2A is a cross-sectional view of a broken line part indicated in FIG. 1B.

FIG. 1A illustrates: a rotor 7 that includes a pole shoe 1, a field coil 2, a shaft 3, a coil support 4 and a bolt 6; a stator 10 that includes an armature coil 8 and a stator core 9; and an air gap 11 between the rotor 7 and the stator 10.

The problem of the occurrence of the temperature difference can be solved by disposing a fin 5 in the coil support 4. The fin 5 forms a windway between the fin 5 and the coil 2b located backward in the rotational direction. A swirl flow generated by the rotation of the rotor 7 hits the fin 5, and is then introduced into the windway formed by the fin 5 and the coil 2b, thereby enabling to enhance the cooling performance of the coil 2b located backward in the rotational direction. Here, the coil support 4 may be detachably configured with respect to the rotor 7. In addition, the fin 5 is formed of a member different from that of the coil support.

In this case, by configuring the windway formed by the fin 5 and the coil 2b to have a width narrower than the gap 11, the flow velocity of the swirl flow increases, thereby enabling to further enhance the cooling performance. As shown in FIG. 1B, when a plurality of coil supports 4 are arranged in the axial direction, even if the fin 5 is disposed only in a coil support located at a position at which the axial flow velocity decreases and an increase in temperature is thus expected, for example, only in a coil support 4b on the central side of FIG. 1B, an effect of reducing the temperature difference occurring in the field coil 2 is exhibited.

Thus, as the result of uniformizing the temperature distribution on a coil region basis to thereby reduce the highest temperature, costs required to cool the coil are reduced, and the efficiency is enhanced, thereby enabling to enhance the life and reliability of the rotating electric machine.

### Example 2

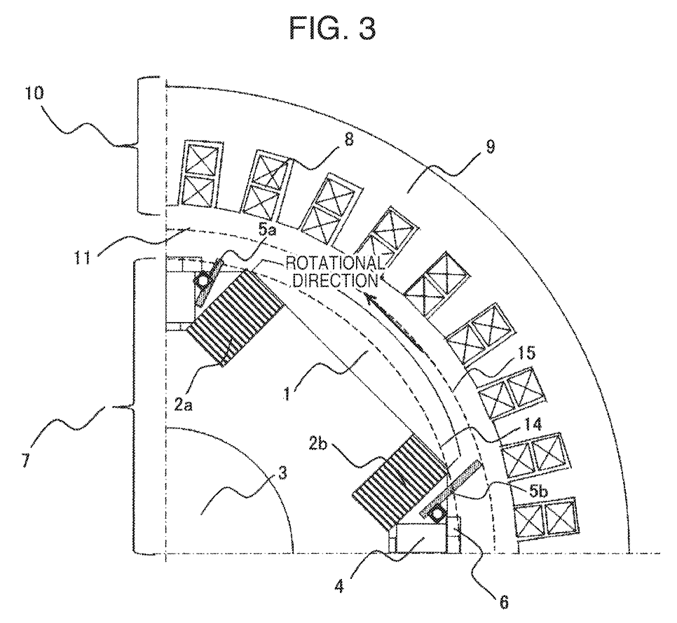

An example 2 of the present invention will be described with reference to FIG. 3. As with FIG. 1A, FIG. 3 illustrates: a rotor 7 that includes a pole shoe 1, a field coil 2, a shaft 3, a coil support 4 and a coil support fastening boll a stator 10 that includes an armature coil 8 and a stator core 9; and an air gap 11 between the rotor 7 and the stator 10.

As the fin 5, there are provided a fin 5a that forms a windway between the fin 5a and a coil 2a located forward in the rotational direction, and a fin 5b that forms a windway between the fin 5b and a coil 2b located backward in the rotational direction. The fin 5a and the fin 5b have respective different shapes and sizes. A radial-direction end part of the fin 5a is located at a position agreeing with a diameter 14 of the end part of the pole shoe 1, and a swirl flow generated by the rotation of the rotor 7 hits the pole shoe 1, and is then introduced into the windway formed by the On 5a and the coil 2a.

Meanwhile, a radial-direction end part of the fin 5b is located at a position agreeing with a diameter 15 corresponding to the center between the inside diameter of the stator 10 and the outside diameter of the rotor 7, and a swirl flow generated by the rotation of the rotor 7 hits the fin 5b, and is then introduced into the windway formed by the fin 5b and the coil 2b. Adjusting the widths and heights of individual windways to keep the flow velocities and the flow rates in balance exhibits an effect of keeping the cooling performance at a position located forward in the rotational direction and the cooling performance at a position located backward in the rotational direction in balance, thereby reducing the temperature difference in the circumferential direction.

Here, when the radial-direction end part of the fin 5 is smaller than the diameter 14 of the end part of the pole shoe 1, the effect of introducing the swirl flow into the windway formed by the fin 5 and the coil 2 is not sufficient, and therefore the effect of the fin is lost. In addition, in contrast, when the radial-direction end part of the fin 5 is larger than a diameter 15 corresponding to the center between the inside diameter of the stator 10 and the outside diameter of the rotor 7, there is an increasing possibility that the radial-direction end part of the fin 5 will come in contact with the stator due to the displacement of the shaft, causing a breakage or the like.

Therefore, configuring the radial-direction end part of the fin 5 to have a diameter falling within a range that is greater than or equal to the diameter 14 of the end part of the pole shoe 1, and that is smaller than or equal to the diameter 15 corresponding to the center between the inside diameter of the stator 10 and the outside diameter of the rotor 7, enables to effectively introduce a swirl flow into the windway formed by the coil 2 and the fin 5, thereby exhibiting an effect of cooling the coil.

In addition, as the result of reducing the temperature difference in the coil, costs required to cool the coil are reduced, and the efficiency is enhanced, thereby enabling to enhance the life and reliability of the rotating electric machine. The fin 5 in the example 2 is provided in a high magnetic field, and therefore is based on the assumption that the fin 5 is made of FRP, CFRP, or Bakelite so as to be non-conductive, and does not generate an eddy current loss.

### Example 3

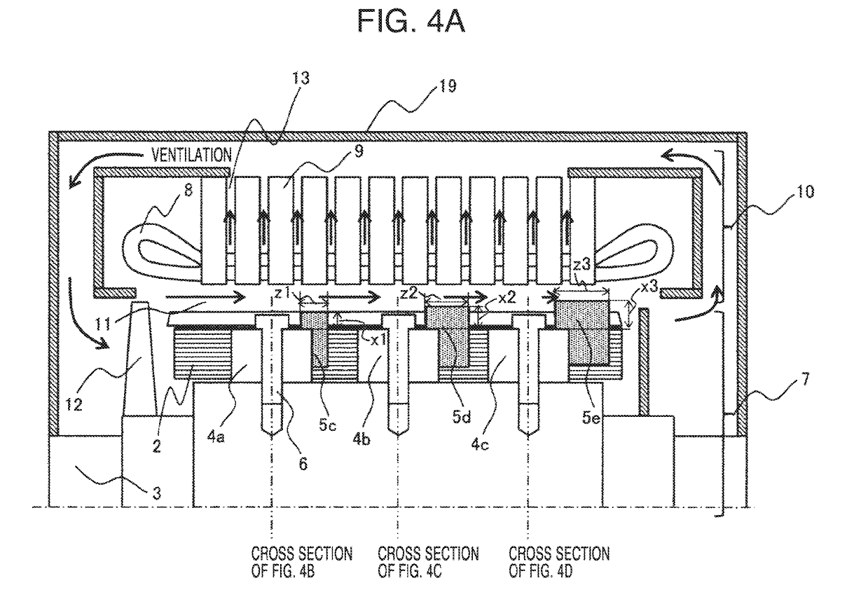

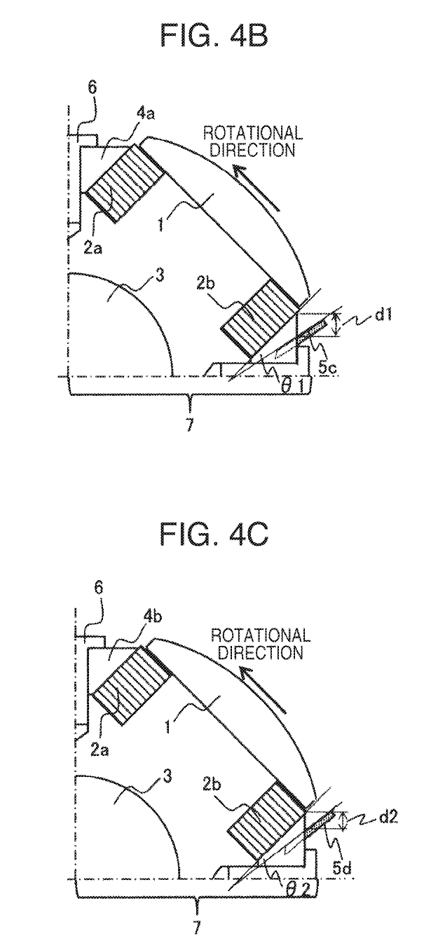

An example 3 of the present invention will be described with reference to FIG. 4A. FIG. 4A illustrates an axial cross-sectional view of a rotating electric machine that includes a rotor 7 and a stator 10, Differently from FIG. 1B and FIG. 2B, only one side is provided with a fan 12.

The fan 12 located at the end part of the rotor generates a ventilation airflow in the axial direction, and the ventilation airflow cools the surface of the rotor 7 and the surface of the stator 10, and causes a refrigerant to pass through a plurality of ducts 13, thereby cooling a stator core 9.

Therefore, the flow velocity in the axial direction decreases with the increasing distance away from the fan 12, and a flow rate also decreases. In this case, as shown in FIG. 4A, the fins 5 according to the present invention are arranged in such a manner that the axial height of each of the fins 5 increases in order from a fin 5c located at a position that is the closest from the fan 12, and at which an axial flow is the fastest, to a central fin 5d, and further to a fin e located at a position that is the farthest from the fan 12, and at which the axial flow is the slowest. In other words, z1<z2<z3 as shown in FIG. 4A. Alternatively, the fins 5 are arranged in such a manner that a diameter of the end part of each of the fins 5 increases in order, In other words, x1<x2<x3 as shown in FIG. 4A.

At the same time, as shown in FIG. 4B, FIG. 4C and FIG. 4D, the fins 5 are arranged in such a manner that the distance between the coil 2b and each of the fins 5 decreases in order. In other words, d1>d2>d3 as shown in FIG. 4B, FIG. 4C and FIG. 4D. Alternatively, θ1>θ2>θ3 as shown in FIG. 4B, FIG. 4C and FIG. 4D. The arrangement of the fins such as that shown in FIG. 4A to FIG. 4D enables to adjust the flow rate and flow velocity of the swirl flow, which is introduced into the windway formed by the coil and each of the fins, for the temperature distribution caused by the difference in flow velocity of the axial flow, the difference depending on a position in the axial direction, and thereby exhibits an effect of reducing the temperature difference that occurs in the axial direction or in the circumferential direction.

In addition, by enhancing the coil cooling performance in a part that faces each of the fins in this manner, an effect of reducing the increase in coil temperature in a part, the ventilation cooling of which is blocked by the coil support, is also achieved, thereby enabling to further uniformize the temperature distribution of the field coil.

Moreover, by bringing the field coil 2, each of the coil supports 4 and each of the fins 5 into intimate contact with one another to decrease the heat resistance, each of the fins exhibits an effect as a cooling fin, thereby enabling to enhance the cooling performance. As the result of reducing the temperature difference in the coil by the enhancements in cooling performance, costs required to cool the coil are reduced, and the efficiency is enhanced, thereby enabling to enhance the life and reliability of the rotating electric machine,

It is assumed that the fins in the example 3 are made of a conductive material such as copper, aluminum alloy, iron or SUS, and that the fins 5 are arranged and fixed to the coil supports 4 by welding to decrease the thermal resistance, and to ensure the structural reliability.

### Example 4

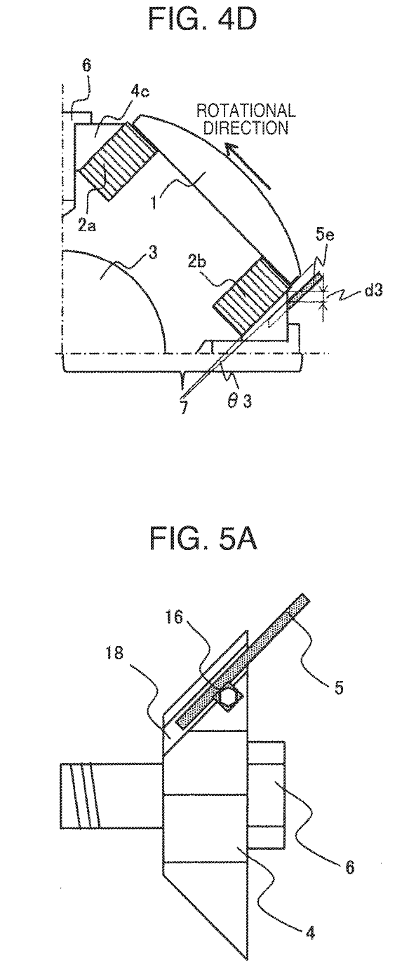

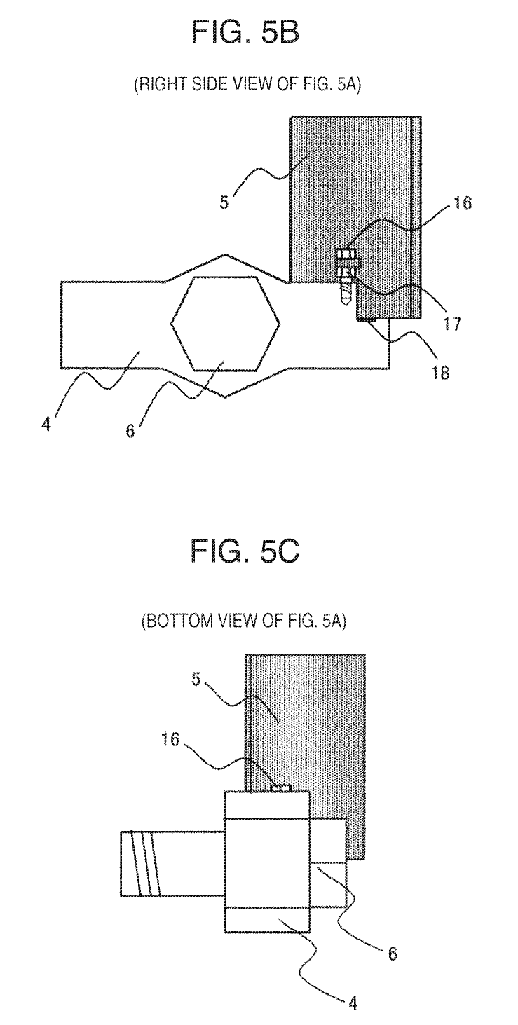

An example 4 of the present invention will be described with reference to FIG. 5A, FIG. 5B and FIG. 5C. FIG. 5A illustrates a coil support 4, a coil support fastening bolt 6 and a fin 5 viewed from the radial cross-sectional view shown in FIG. 1A. FIG. 5B is a right side view of FIG. 5A; and FIG. 5C is a bottom view of FIG. 5A.

The fin 5 of the present invention is provided in the coil support 4 by a nut 17, and a component 16 used both as a fin fastening bolt and a fin-height adjusting screw The fin has a structure in which a past of the fin 5 is buried into a groove 18 provided in the coil support 4, and the fin height can be adjusted within a range of the screw length of the component 16 used both as a fin fastening bolt and a fin-height adjusting screw.

At the same time, a mounting angle of the fin can be adjusted within a range of the width of the groove 18 provided in the coil support 4. By using such a structure capable of changing the height or angle of the fin, even when such a temperature distribution unexpected at the beginning occurs in the field coil, the flow rate and flow velocity of the swirl flow can be obtained as desired by adjusting the fin provided in a high temperature part, thereby enabling to adjust the temperature distribution.

In addition, as the result, the life and reliability of the rotating electric machine can be enhanced.

### Example 5

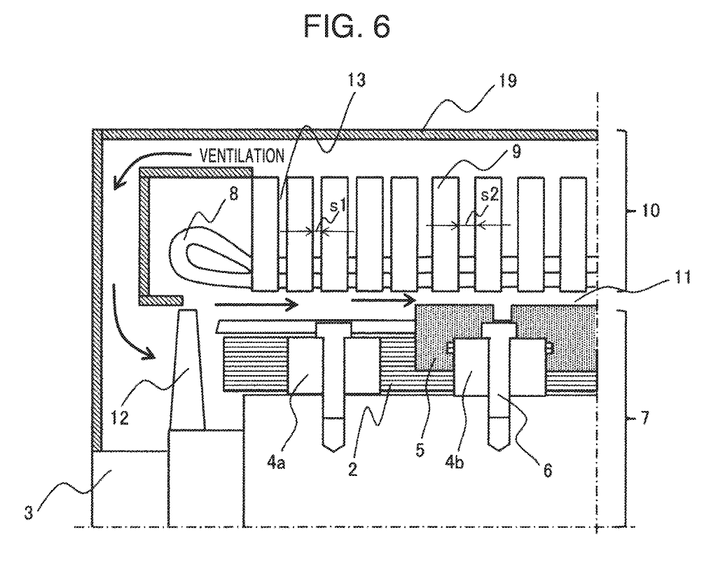

An example 5 of the present invention will be described with reference to FIG. 6, As with FIG. 1B, FIG. 6 is an axial cross-sectional view illustrating a half (½) of a rotating electric machine that includes a stator 10, and a rotor 7 having a structure symmetric with respect to the axial center.

Both ends are provided with fans 12 respectively, and therefore a fin 5 is provided in a coil support 4b in proximity to the axial center at which the axial flow becomes substantially 0. The structure of the components and the effect thereof are similar to those of the example 1. Here, in addition to the structure of the example 1, ducts 13 are configured in such a manner that the width S2 of the duct 13 located at a position facing the fin 5 is made wider than the width Si of the duct 13 located at a position that does not face the fin 5, and consequently the widths of the ducts are changed so as to satisfy the expression S1<S2.

As described in the example 1 and the example 2, when the flow velocity of the axial flow decreases, the temperature of the rotor and the temperature of the field coil increase in a part in which the flow rate decreases. However, the temperature increase due to a similar cause occurs on the stator side too. For this reason, the present structure of widening the widths of the ducts 13, each of which is located at a position facing the fin 5 and the coil support 4 provided with the fin 5, in the stator 10 enables to adjust the flow rate of the refrigerant passing through the ducts in the radial direction, to ensure the flow rate toward the axial center, the temperature of which becomes high, and to decrease a temperature gradient. In addition, as the result, the life and reliability of the rotating electric machine can be enhanced.

In addition, the configuration in which the fin on the rotor side and the widths of the ducts on the stator side are combined in this manner enhances the cooling performance, and enables to minimize the number of fins, and to promote the effect of the example 1 without increasing the number of components.

### Example 6

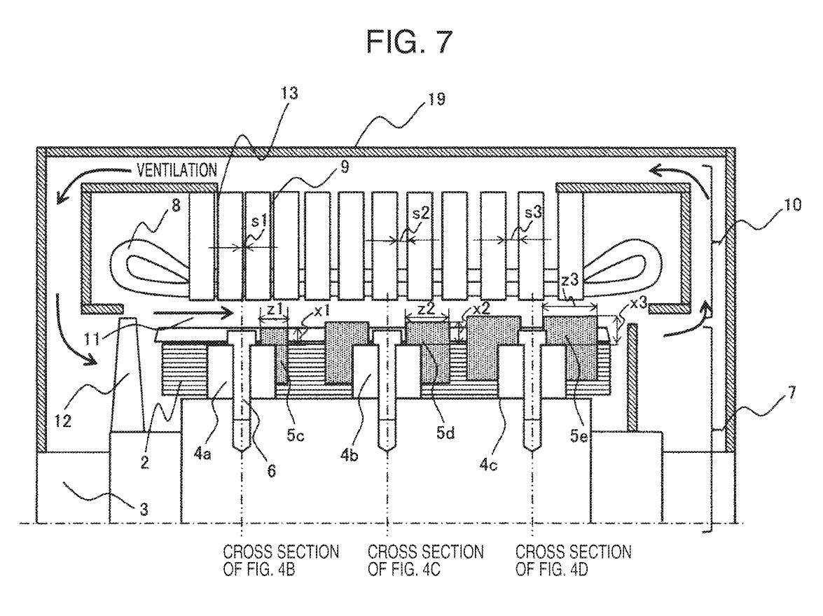

An example 6 of the present invention will be described with reference to FIG. 7. As with FIG. 4A, FIG. 7 is a cross-sectional view of a rotating electric machine that includes a stator 10, and a rotor 7 having a fan 12 on one side. Fins 5c, 5d and 5e provided in coil supports 4a, 4b and 4c respectively have the same features and effects as those described in the example 3.

Furthermore, here, ducts 13 are configured in such a manner that on the assumption that the ducts 13 located at positions each facing the coil support 4a and the fin 5c each have a width of S1, the ducts 13 located at positions each facing the coil support 4b and the fin 5d each have a width of S2, and the ducts 13 located at positions each facing the coil support 4c and the fin 5e each have a width of S3, the relationship among the duct widths satisfies the expression of S1<S2<S3. S1, S2 and S3 are representative sizes for the three coil supports, and the fins mounted to the coil supports respectively. However, a structure in Which the duct width gradually increases from the duct closest to the fan up to the duct farthest to the fan is also included in this example.

The present structure enables to adjust the flow rate of the refrigerant passing through the ducts in the radial direction, to ensure the flow rate toward the axial center, the temperature of which becomes high, and to decrease a temperature gradient. In addition, as the result, the life and reliability of the rotating electric machine can be enhanced. Moreover, the configuration in Which the fins and the widths of the ducts are combined in this manner enhances the cooling performance, and enables to minimize the number of fins, and to promote the effect of the example 1 without increasing the number of components.

### Example 7

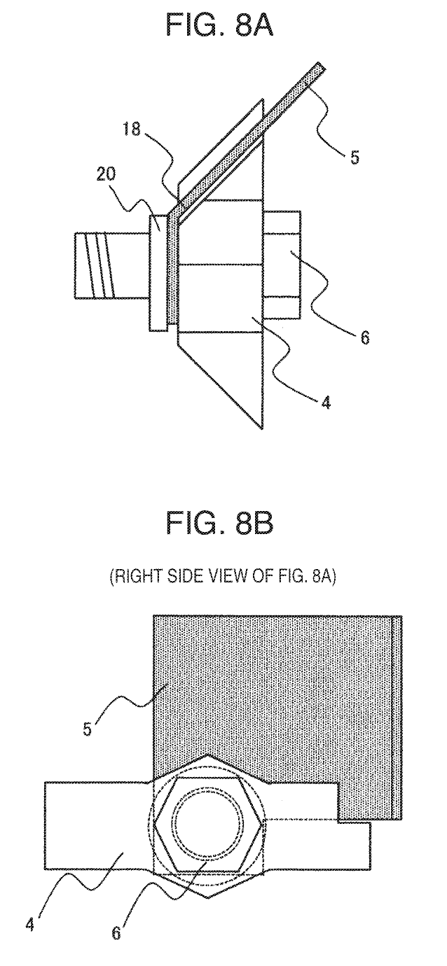

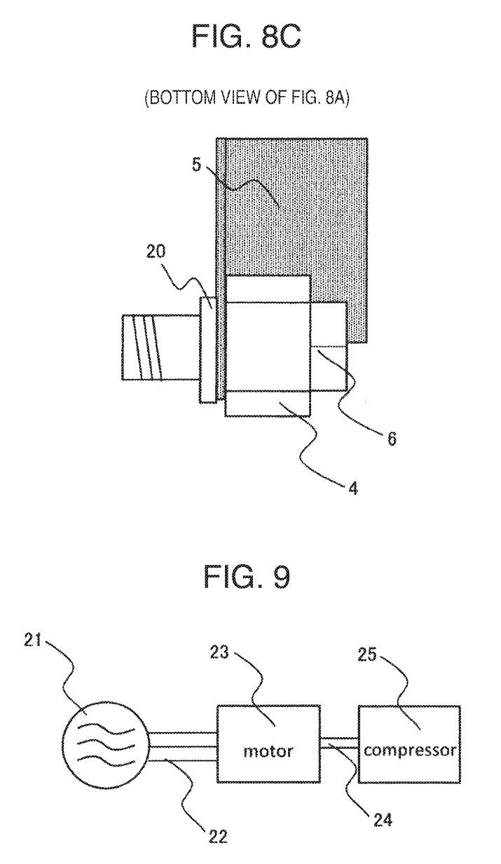

An example 7 of the present invention will be described with reference to FIG. 8A, FIG. 8B and FIG. 8C. FIG. 8A illustrates a coil support 4 and a coil support fastening boll 6 viewed from the radial cross-sectional view shown in FIG. 1A. The fin 5 in the present example differs from the fin 5 shown in each of FIG. 1A and FIG. 5A in the method for mounting the fin 5 to the coil support 4.

The fin 5 in the present example is Characterized by being formed of rubber, and therefore even when the fin 5 is broken, other structures are hardly damaged, In addition, when the stator is inserted, the fin protrudes from the pole shoe, which allows easy contact, and even when a contact is made, a problem such as a scratch does not arise, and consequently the productivity is improved. The fin 5 formed of rubber is formed with a hole into which a bolt 6 can he inserted. As shown in FIG. 8A, the fin 5 is put between the coil support 4 and a stiffening plate (metal plate) 20 to fix the fin 5.

In this case, it is difficult to insert the fin 5 into a groove of the coil support, and therefore, as shown in FIG. 8A and FIG. 8B, the fin 5 is arranged with the coil support 4 partially notched.

### Example 8

An example 8 of the present invention will be described with reference to FIG. 9. FIG. 9 illustrates a compressor system in which the power is supplied from a power source 21 to an electric motor 23 having the structure according to the present invention through a wiring line 22, and a compressor 25 is driven by the electric motor 23 through a shaft 24. Configuring the compressor system to use the electric motor 23 according to the present invention enables the stable operation of the whole system, thereby enabling the system to achieve high reliability and long life.

### REFERENCE NUMERALS

1 . . . pole shoe, 2 . . . field coil, 2a . . . forward in rotational direction, 2b . . . backward in rotational direction, 3 . . . shaft, 4 . . . coil support, 4a . . . end part (upstream) side in axial direction, 4b . . . center side in axial direction, 4c . . . end part (downstream) side in axial direction, 5 . . . fin, 5a . . . forward in rotational direction, 5b . . . backward in rotational direction, 5c . . . end part (upstream) side in axial direction, 5d . . . center side in axial direction, 5e . . . end part (downstream) in axial direction, 6 . . . coil support fastening bolt, 7 . . . rotor, 8 . . . armature coil, 9 . . . stator core, 10 . . . stator, 11 . . . gap, 12 . . . fan, 13 . . . duct, 14 . . . minimum diameter of end part of pole shoe, 15 . . . diameter corresponding to center between inside diameter of stator and outside diameter of rotor, 16 . . . component used both as fin fastening bolt and fin-height adjusting screw, 17 . . . nut, 18 . . . groove provided in coil support, 19 . . . frame, 20 . . . stiffening plate, 21 . . . power source, 22 . . . wiring line, 23 . . . electric motor of present application, 24 . . . shaft, 25 . . . compressor

1. A rotating electric machine comprising:
a stator;
a rotor disposed in such a manner that an outer peripheral surface of the rotor faces an inner peripheral surface of the stator; and
a plurality of coil supports that support between poles of a coil forming the rotor, wherein
at least one of the coil supports is provided with a fin, and
the fin is provided in such a manner that a windway through which a swirl flow occurring with a rotation of the rotor passes is formed between the coil and the fin.

2. The rotating electric machine according to claim 1, wherein
a diameter of an end part of the fin is greater than or equal to a diameter of an end part of a pole shoe 1 in the rotor, and is smaller than or equal to a diameter corresponding to the center between a diameter of the inner peripheral surface of the stator and a diameter of the outer peripheral surface of the rotor.

3. The rotating electric machine according to claim 1, wherein
a distance between the fin and the coil, and an axial length of the fin vary depending on an axial position of each of the coil supports, and vary depending on whether a region of the coil forming the windway is located forward or backward in a rotational direction.

4. The rotating electric machine according to claim 1, wherein
at least one of a width, a height and an angle of the fin is variable.

5. The rotating electric machine according to claim 1, wherein
the stator is provided with a plurality of duct spaces in an axial direction, and each of the duct spaces located at a position facing the fin 5 and the coil support provided with the fin has a width larger than a width of each of the duct spaces located at a position that does not face the fin 5.

6. The rotating electric machine according to claim 1, wherein
the stator is provided with a plurality of duct spaces in an axial direction, and when the fin has a maximum width or height, or when a width of the windway formed by the fin and the coil is narrowest, each duct space located at a position facing the fin and the coil support provided with the fin has a maximum width.

7. The rotating electric machine according to claim 1, wherein
the fin is formed of rubber.

8. A compressor system, wherein
the electric motor is used as a compressor driving machine in claim 1.
